(19) United States
(12) Patent Application Publication
(10) Pub. No.: US 2004/0193458 A1
(43) Pub. Date: Sep. 30, 2004

(54) Method and system for matching an open appointment to a client

(76) Inventor: Barbara E. Bear, Boca Raton, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/808,005

(22) Filed: Mar. 24, 2004

Related U.S. Application Data
(60) Provisional application No. 60/457,658, filed on Mar. 26, 2003.

(51) Int. Cl. G06F 17/60

(52) U.S. Cl. 705/5

(57) ABSTRACT

A computer-implemented automated interactive method for matching an open appointment to a client is disclosed including electronically generating a client list of at least one client having a scheduled appointment, the at least one client requiring a different appointment than the scheduled appointment, electronically generating an appointment list of at least one open appointment time slot, correlating the client list to the appointment list to generate a contact list, the contact list containing at least one appointment option based on the at least one client and the at least one open appointment time slot, electronically communicating the at least one appointment option to the at least one client, the at least one appointment option having a time of availability different than the scheduled appointment, and electronically selecting the at least one appointment option by the at least one client to fill the at least one open appointment time slot.

### CROSS-REFERENCE TO RELATED APPLICATIONS

This application claims the benefit of U.S. Provisional Application Serial No. 60/457,658, filed on Mar. 26, 2003, entitled METHOD AND SYSTEM FOR MATCHING AN OPEN APPOINTMENT TO A USER.

### TECHNICAL FIELD OF THE INVENTION

This invention generally relates to improvements in electronic scheduling of appointments; and more particularly, to canceling or rescheduling prior appointments to new dates and times.

### BACKGROUND OF THE INVENTION

There have been disclosed a number of different electronic schedulers and systems for more efficiently managing the use of time by both individuals and businesses, including U.S. Pat. No. 4,162,610 and U.S. Pat. No. Re. 32,655; U.S. Pat. No. 4,548,510; U.S. Pat. No. 4,769,796; and U.S. Pat. No. 4,783,800. In such schedulers, a number of appointments are entered and stored in a memory for a number of different time periods in the future and are retained in retrievable form as a rapidly accessible record of a user or users future commitments. At the convenience of the user, the schedules of appointments for any selected time period, or periods, are selectively retrieved from the memory and communicated by any one of a visual display, a printed record, or an audible announcement. Alternatively, or additionally, a subschedule of free or available time slots are selectively determined from the memory for any selected future time period in order to assist the user in making, and subsequently confirming, a new appointment in the future.

Additionally, in such earlier patents, any of the appointments stored in the memory can be randomly cancelled or rescheduled by erasing the memory for that time slot and reentering a new appointment for a different time.

However, the occurrence of an unexpected event, such as an emergency or other event of greater priority, often makes it necessary for an office to cancel an appointment or an entire series of appointments on a given day, or time period, and to reschedule each of such cancelled appointments to other times that are more convenient and available to all parties concerned.

Conversely, it is often necessary that an individual scheduled for an appointment with an office be required to cancel an appointment or reschedule the appointment to a different time. The rescheduling of such appointments, whether by a office or an individual, is often difficult and time consuming, particularly where the office is very busy, receiving many calls daily, and dealing with many persons during a typical working day. Furthermore, where the need arises to cancel or reschedule an appointment at a time after normal business hours, the prior appointment is often missed or the rescheduling is delayed until that office reopens for business on the following business day. Such situations an often costly and inconvenience both the individual and the office.

Rescheduling an entire series of appointments for a day or other time period is often a particularly difficult and time consuming chore for many busy offices, such as those of doctors, dentists, attorneys, and other like professional and business persons whose active practices include many appointments with different persons during a typical working day. Present practice followed requires that an office employee, such as a nurse, receptionist, or appointment clerk, telephone each such patient, client, or customer, and individually reschedule each such person, client, or customer, for a new appointment at a substitute time that is not only convenient to that person, but also available to that office. Frequently, multiple appointment rescheduling is very time consuming, often resulting in “doubling up” of appointments, or prolonging the office visit to a date in the future other than that desired by the patient, client, or other person.

Thus, there is a need for an electronic scheduling system and method that correlates a client list against an appointment database to determine available appointment times for clients on the client list and subsequently generates an automated query to at least on client on the client list to permit the client to accept an open appointment. Additionally, there is a need for an electronic scheduling system and method that permits a client to electronically cancel an appointment from an appointment database and reschedule the appointment.

### SUMMARY OF THE INVENTION

The present invention eliminates the above-mentioned needs for an electronic scheduling system and method that correlates a client list against an appointment database to determine available appointment times for clients on the client list and subsequently generates an automated query to at least on client on the client list to permit the client to accept an open appointment by providing automated interactive method for matching an open appointment to a user that provides better accuracy an ease of operation for electronic scheduling.

In accordance with the present invention, there is provided a computer-implemented automated interactive method for matching an open appointment to a client, including electronically generating a client list of at least one client having a scheduled appointment, the at least one client requiring a different appointment than the scheduled appointment, electronically generating an appointment list of at least one open appointment time slot, correlating the client list to the appointment list to generate a contact list, the contact list containing at least one appointment option based on the at least one client and the at least one open appointment time slot, electronically communicating the at least one appointment option to the at least one client, the at least one appointment option having a time of availability different than the scheduled appointment, and electronically selecting the at least one appointment option by the at least one client to fill the at least one open appointment time slot.

### BRIEF DESCRIPTION OF THE FIGURES

FIG. 1 is a flow chart diagram of the preferred embodiment of the present invention.

### DETAILED DESCRIPTION OF THE PREFERRED EMBODIMENTS

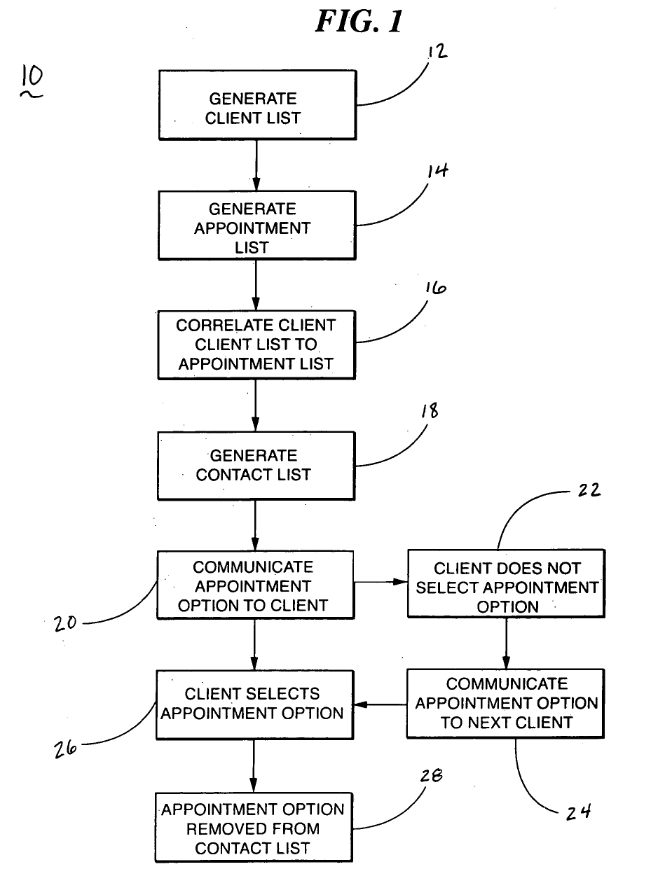

Referring now to FIG. 1, a preferred embodiment of the present invention is illustrated as automated interactive matching system 10. Automated interactive matching system 10 is shown as a series of steps, 12 through 28.

In the preferred embodiment, automated interactive matching system 10 generates a list of clients through Generate Client List Step 12. Such a listing of clients, such as patients of a physician, dentist, or veterinarian, client-customers of a vehicle service facility, or the like can be generated from the existing computer network of the facility implementing the present invention. It is preferred that the clients already have existing appointments, such as periodic check-ups (such as a mammogram or physical) or interval services (such as an oil change), and that such clients would prefer an earlier or later appointment if such earlier or later appointment is feasible.

It is further preferred that the client list created through Generate Client List Step 12 includes at least a client identifier and a client contact. The client identifier can incorporate information including, but not limited to, name, address, insurance information, or the like. The client contact can include, but is not limited to, telephone numbers and/or electronic mail (email) addresses for the client.

Similarly, Generate Appointment List Step 14 creates an appointment list of available appointments for the client. Preferably, the appointment list created through Generate Appointment List Step 14 includes at least one available time slot for the client. More preferably the available appointments are appointment times that were previously unavailable and have become available as a result of a client cancellation.

Automated interactive matching system 10 then correlates the client list to the appointment list of cancelled appointment times that have become open (available) at Correlation Step 16 to generate a contact list at Generate Contact List Step 18, the contact list containing at least one appointment option based on the at least one client and the at least one open appointment time slot, i.e. the recently cancelled appointment time that has been made available. In one embodiment, Correlation Step 16 correlates a single client of the client list to an open appointment time slot of the appointment list, matching the client to an appointment. In another embodiment, a plurality of clients of the client list is matched to a plurality of open appointment time slots. In still another embodiment, a plurality of clients is matched to a single appointment. The matches of client to appointment are then formed into a contact list through Generate Contact List Step 18.

Once the contact list is generated, automated interactive matching system 10, communicates an appointment option to a client through Communicate Appointment Option Step 20. Such communication is accomplished via electronic communication, for example by telephone or electronic mail (email). The communication to the client can be based upon either contact initiated by the client or by automated interactive matching system 10. Such a client-initiated system is beneficial since offices, such as physician offices, are often too overburdened or closed and unable to handle rescheduling in a timely manner. In the situation where automated interactive matching system 10 initiates the contact with the client, the selection of the order in which the clients are communicated can be accomplished by using a preferential contacting scheme, such as arranging the clients to be contacted in alphabetical order, numerical order based upon telephone number or zip code, or the like.

By way of example, if the client receives a telephone communication from Communicate Appointment Option Step 20 of automated interactive matching system 10, the client can choose not to select an appointment option, as in Appointment Option Step 22. This can be done by selecting the appropriate option from a telephone menu, as is well known in the art. If the client selects the appointment option, the client's previously scheduled appointment is cancelled and the cancelled appointment is then available as an open appointment time slot. If the client does not select the appointment option, another appointment option is created by Correlation Step 16, which correlates the client to a second open appointment time slot of the appointment list, matching the client to the second appointment slot. The second appointment option is then communicated to the client in the same manner as the first appointment option. If the second open appointment option is acceptable to the client, the client selects the appointment at Select Appointment Option Step 26 and the client's previously scheduled appointment is cancelled and the cancelled appointment is then available as an open appointment time slot. This process is repeated until the client either accepts an appointment time or terminates the call.

The rejected appointment options are dealt with in a manner consistent with the way the client was matched to the appointment. For example, if a plurality of clients were matched to a single appointment option, then the rejected appointment is communicated to the next client on the contact list, as in Communicate Appointment Option To Next Client Step 24, until the appointment option is selected at Select Appointment Option Step 26.

Once the appointment option is selected at Select Appointment Option Step 26, it is removed from the contact list and replaced with the client's cancelled previous appointment at Appointment Option Removal Step 28 so as to prevent multiple clients from selecting the identical appointment option.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following appended claims.

What is claimed is:

1. A computer-implemented automated interactive method for matching an open appointment to a client, comprising:
electronically generating a client list of at least one client having a scheduled appointment, said at least one client requiring a different appointment than said scheduled appointment;
electronically generating an appointment list of at least one open appointment time slot;
correlating said client list to said appointment list to generate a contact list, said contact list containing at least one appointment option based on said at least one client and said at least one open appointment time slot;
electronically communicating said at least one appointment option to said at least one client, said at least one appointment option having a time of availability different than said scheduled appointment; and
electronically selecting said at least one appointment option by said at least one client to fill said at least one open appointment time slot.

2. The method according to claim 1 further comprising:
removing said selected at least one appointment option from said contact list;
canceling said scheduled appointment of said at least one client; and
placing said cancelled appointment in said appointment list.

3. The method according to claim 1 wherein said electronic communication of said at least one appointment option to said at least one client is by telephone.

4. The method according to claim 1 wherein said electronic communication of said at least one appointment option to said at least one client is by electronic mail.

5. A computer-implemented automated interactive method for matching an open appointment to a client, comprising:
electronically generating a client list of a plurality of clients each client of said plurality of clients having a scheduled appointment, each client of said plurality of clients requiring a different appointment than said scheduled appointment;
electronically generating an appointment list of at least one open appointment time slot;
correlating said client list to said appointment list to generate a contact list, said contact list containing at least one appointment option based on said plurality of clients and said at least one open appointment time slot;
electronically communicating said at least one appointment option to each client of said plurality of clients, said at least one appointment option having a time of availability different than said scheduled appointment; and
electronically selecting said at least one appointment option by said at least one client of said plurality of clients to fill said at least one open appointment time slot.

6. The method according to claim 5 further comprising:
removing said selected at least one appointment option from said contact list;
canceling said scheduled appointment of said at least one client of said plurality of clients; and
placing said cancelled appointment in said appointment list.

7. The method according to claim 5 wherein said electronic communication of said at least one appointment option to said at least one client of said plurality of clients is by telephone.

8. The method according to claim 5 wherein said electronic communication of said at least one appointment option to said at least one client of said plurality of clients is by electronic mail.

9. A computer-implemented automated interactive method for matching an open appointment to a client, comprising:
electronically generating a client list of at least one client having a scheduled appointment, said at least one client requiring a different appointment than said scheduled appointment;
electronically generating an appointment list of at least one open appointment time slot;
correlating said client list to said appointment list to generate a contact list, said contact list containing at least one appointment option based on said at least one client and said at least one open appointment time slot;
electronically communicating said at least one appointment option to said at least one client, said at least one appointment option having a time of availability different than said scheduled appointment;
electronically selecting said at least one appointment option by said at least one client to fill said at least one open appointment time slot;
removing said selected at least one appointment option from said contact list;
canceling said scheduled appointment of said at least one client; and
placing said cancelled appointment in said appointment list;
wherein a rejected appointment option is electronically communicated to a second client, and wherein a cancelled appointment is electronically communicated to said second client.
